(19) United States
(12) Patent Application Publication
(10) Pub. No.: US 2026/0359575 A1
(43) Pub. Date: Nov. 12, 2026

(54) INFORMATION PROCESSING APPARATUS, ATTRIBUTE INFORMATION EXTRACTION METHOD, AND STORAGE MEDIUM

(71) Applicant: NEC Corporation, Tokyo (JP)

(72) Inventors: Genki KUSANO, Tokyo (JP); Masafumi OYAMADA, Tokyo (JP); Masafumi ENOMOTO, Tokyo (JP); Shogo HAYASHI, Tokyo (JP)

(73) Assignee: NEC Corporation, Tokyo (JP)

(21) Appl. No.: 19/139,914

(22) PCT Filed: Dec. 26, 2022
(86) PCT No.: PCT/JP2022/048009

§ 371 Date: Jun. 17, 2025

(51) Int. Cl. G06F 40/40; G06F 40/166; G06F 40/289

(52) U.S. Cl. CPC G06F 40/40; G06F 40/166; G06F 40/289

(57) ABSTRACT

To add attribute information to target data without using a search query or the like for decision making, an information processing apparatus (2) includes: a related string generation section (204) that generates, from a target string regarding target data to which attribute information is to be added, a related string related to the target string with use of a language model (212) trained with relationships between terms; and an attribute information extraction section (205) that extracts the attribute information from the related string.

### TECHNICAL FIELD

The present invention relates to an information processing apparatus or the like that adds attribute information to target data.

### BACKGROUND ART

A technique of automatically adding, to data to be analyzed, attribute information that indicates an attribute of the data has been conventionally known. For example, Patent Literature 1 below discloses an information processing apparatus that extracts both a first keyword corresponding to a predetermined target and a second keyword regarding a property of the target from a search query, and provides the extracted second keyword as target demand information regarding demand of the target. According to this information processing apparatus, for example, in a case where, among search queries from which the first keyword “vehicle X” is extracted, the ratio of search queries from which the second keywords such as “lateral width”, “platform area”, etc. is high, it is possible to provide information such as “lateral width” and “platform area” as the target demand information regarding the demand of the “vehicle X”.

### CITATION LIST

### Patent Literature

[Patent Literature 1]

Japanese Patent Application Publication Tokukai No. 2020□102029

### SUMMARY OF INVENTION

### Technical Problem

However, this conventional art is based on the premise that search queries inputted by various users can be obtained, and it is generally difficult to obtain such search queries. An example object of an example aspect of the present invention is to realize an information processing apparatus or the like capable of adding attribute information to target data without using a search query or the like.

### Solution to Problem

An information processing apparatus in accordance with an example aspect of the present invention includes: related string generation means for generating, from a target string regarding target data to which attribute information is to be added, a related string related to the target string with use of a language model trained with relationships between terms; and attribute information extraction means for extracting the attribute information from the related string.

An attribute information extraction method in accordance with an example aspect of the present invention includes: generating, by at least one processor, from a target string regarding target data to which attribute information is to be added, a related string related to the target string with use of a language model trained with relationships between terms; and extracting, by the at least one processor, the attribute information from the related string.

An attribute information extraction program in accordance with an example aspect of the present invention causes a computer to function as: related string generation means for generating, from a target string regarding target data to which attribute information is to be added, a related string related to the target string with use of a language model trained with relationships between terms; and attribute information extraction means for extracting the attribute information from the related string.

### Advantageous Effects of Invention

According to an example aspect of the present invention, it is possible to add attribute information to target data without using a search query or the like.

### BRIEF DESCRIPTION OF DRAWINGS

FIG. 1 is a block diagram illustrating the configuration of an information processing apparatus in accordance with a first example embodiment of the present invention.

FIG. 2 is a flowchart illustrating the flow of an attribute information extraction method in accordance with the first example embodiment of the present invention.

FIG. 3 is a diagram illustrating an example of extracting attribute information by the attribute information extraction method in accordance with a second example embodiment of the present invention.

FIG. 4 is a block diagram illustrating an example configuration of an information processing apparatus in accordance with the second example embodiment of the present invention.

FIG. 5 is a diagram illustrating an example of tables from which related terms are to be extracted.

FIG. 6 is a diagram illustrating an example in which attribute information is extracted with use of a language model trained to output, in response to input of a sentence having a missing part, a string appropriate to fill the missing part.

FIG. 7 is a diagram illustrating an example of extracting attribute information based on frequencies of occurrence of terms extracted from two or more related strings.

FIG. 8 is a flowchart illustrating the flow of an attribute information extraction method in accordance with the second example embodiment of the present invention.

FIG. 9 is a diagram illustrating an example of a computer that executes instructions of a program which is software implementing the functions of the apparatuses in accordance with the example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for an example embodiment described later.

### Configuration of Information Processing Apparatus

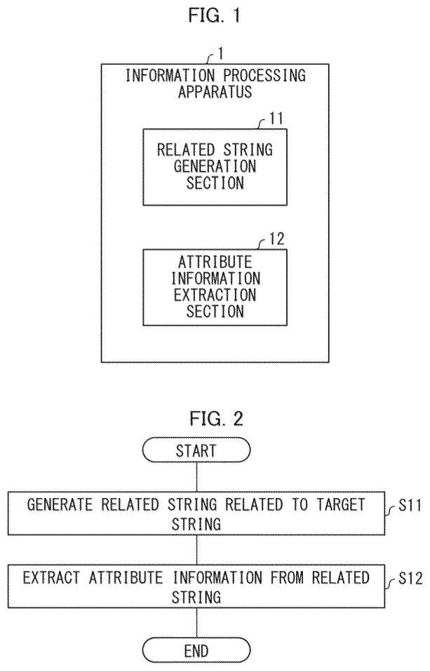

The following description will discuss the configuration of an information processing apparatus 1 in accordance with the present example embodiment with reference to FIG. 1. FIG. 1 is a block diagram illustrating the configuration of the information processing apparatus 1. As illustrated in FIG. 1, the information processing apparatus 1 includes a related string generation section (related string generation means) 11 and an attribute information extraction section (attribute information extraction means) 12.

The related string generation section 11 generates, from a target string regarding target data to which attribute information is to be added, a related string related to the target string with use of a language model trained with relationships between terms.

The attribute information extraction section 12 extracts attribute information from the related string generated by the related string generation section 11.

Thus, the information processing apparatus 1 in accordance with the present example embodiment includes: the related string generation section 11 that generates, from a target string regarding target data to which attribute information is to be added, a related string related to the target string with use of a language model trained with relationships between terms; and the attribute information extraction section 12 that extracts the attribute information from the related string generated by the related string generation section 11. Therefore, the information processing apparatus 1 in accordance with the present example embodiment achieves an example advantage of being capable of adding attribute information to target data without using a search query or the like.

### Attribute Information Extraction Program

The foregoing functions of the information processing apparatus 1 may be implemented by a program. Thus, the attribute information extraction program in accordance with the present example embodiment causes a computer to function as: the related string generation section 11 that generates, from a target string regarding target data to which attribute information is to be added, a related string related to the target string with use of a language model trained with relationships between terms; and the attribute information extraction section 12 that extracts the attribute information from the related string generated by the related string generation section 11. Therefore, the attribute information extraction program in accordance with the present example embodiment achieves an example advantage of being capable of adding attribute information to target data without using a search query or the like.

### Flow of Attribute Information Extraction Method

The following description will discuss the flow of an attribute information extraction method in accordance with the present example embodiment with reference to FIG. 2. FIG. 2 is a flowchart illustrating the flow of the attribute information extraction method. It should be noted that steps illustrated in FIG. 2 may be carried out by a processor of the information processing apparatus 1 or by a processor of another apparatus. Alternatively, the steps may be carried out by processors provided in respective different apparatuses.

In S11, at least one processor generates, from a target string regarding target data to which attribute information is to be added, a related string related to the target string with use of a language model trained with relationships between terms.

In S12, the at least one processor extracts the attribute information from the related string generated in S11.

Thus, the attribute information extraction method in accordance with the present example embodiment includes: generating, by at least one processor, from a target string regarding target data to which attribute information is to be added, a related string related to the target string with use of a language model trained with relationships between terms; and extracting, by the at least one processor, the attribute information from the generated related string. Therefore, the attribute information extraction method in accordance with the present example embodiment achieves an example advantage of being capable of adding attribute information to target data without using a search query or the like.

### Second Example Embodiment

### Outline of Attribute Information Extraction Method

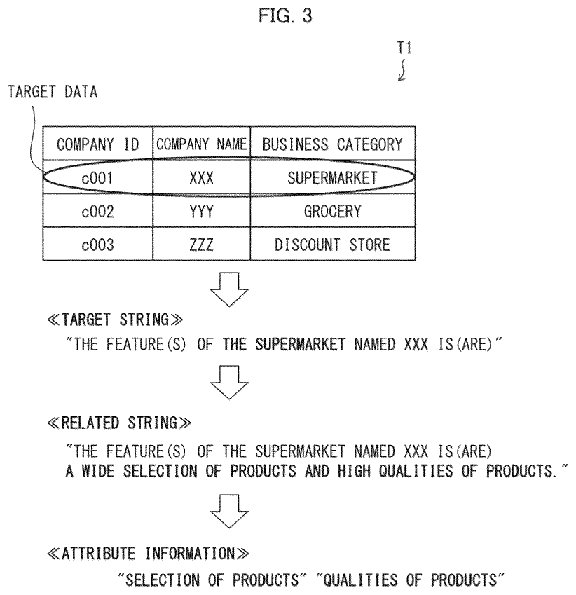

The following description will discuss the outline of an attribute information extraction method in accordance with the present example embodiment (hereinafter, referred to as the “present method”), with reference to FIG. 3. FIG. 3 is a diagram illustrating an example of extracting attribute information by the present method. Table T1 illustrated in FIG. 3 shows input data inputted by a user. In the table T1, a record of the company ID “c001” is target data designated as a target to which attribute information is to be added. The target data may be the entire record or may be one of the pieces of data included in a record. Further, data in any format besides the table format may be used as the target data.

The table T1 shows that the company name of the company with the company ID “c001” is “XXX” and the business category is “supermarket”; however, other information is unknown. According to the present method, it is possible to add attribute information to such target data without using a search query or the like.

First, according to the present method, a target string regarding target data to which attribute information is to be added is generated. In the example of FIG. 3, a sentence “The feature(s) of the supermarket named XXX is(are)” is generated as the target string. This sentence includes “XXX”, which is a string indicating the name of the target data, and “supermarket”, which is a related term related to the target data.

Subsequently, according to the present method, from the generated target string, a related string related to the target string is generated. Although details will be described later, the related string is generated by using a language model trained with relationships between terms. In the example of FIG. 3, with the latter half of the target string supplemented, a sentence “The feature(s) of the supermarket named XXX is(are) a wide selection of products and high qualities of products” is generated as the related string.

Then, according to the present method, attribute information is extracted from the generated related string. In the example of FIG. 3, the terms “selection of products” and “qualities of products” included in the related string are extracted as the attribute information. Each of these terms indicates a property of the target data, and is a useful term as the attribute information of the target data. Thus, according to the present method, it is possible to add attribute information to target data without using a search query or the like.

### Configuration of Information Processing Apparatus

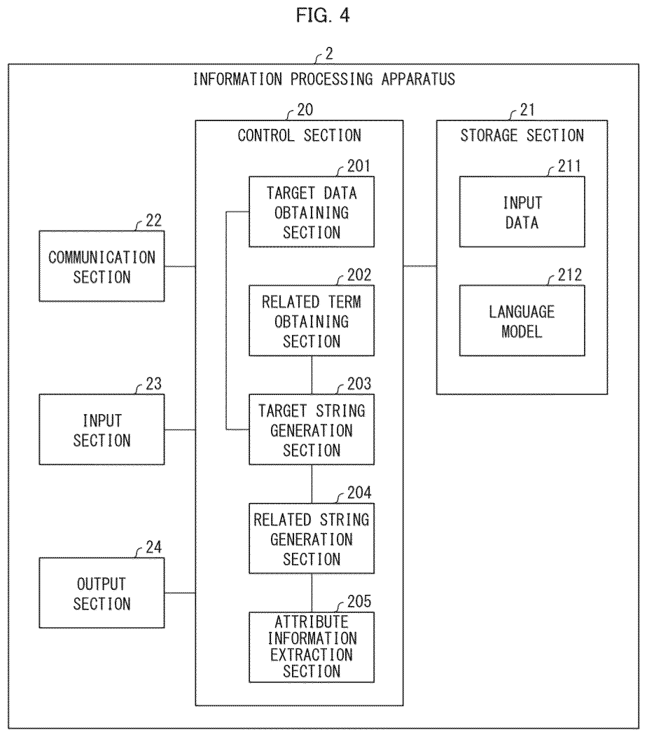

FIG. 4 is a block diagram illustrating an example configuration of the information processing apparatus 2 in accordance with the present example embodiment. As illustrated in FIG. 4, the information processing apparatus 2 includes: a control section 20 that collectively controls sections of the information processing apparatus 2; a storage section 21 that stores various kinds of data; a communication section 22 for communicating with another apparatus; an input section 23 that accepts input operation; and an output section 24 that outputs data.

The control section 20 includes a target data obtaining section 201, a related term obtaining section 202, a target string generation section 203, a related string generation section 204, and an attribute information extraction section 205. The storage section 21 stores input data 211 and the language model 212.

The target data obtaining section 201 obtains target data to which attribute information is to be added. For example, the target data obtaining section 201 may extract the target data from the input data 211. The input data 211 may include one or more pieces of data, and the input data 211 may be inputted by a user, may be previously stored in the storage section 21, or may be obtained via the communication section 22. For example, the input data 211 may be a dataset such as that illustrated as the table T1 of FIG. 3. In this case, the target data obtaining section 201 may obtain, as the target data, a record or data included in the input data 211. Here, the user may be made to select which piece of data in the input data 211 to designate as the target data. The method of obtaining the target data is not particularly limited, and for example, the data obtaining section 201 may obtain target data inputted by the user via the input section 23, or may obtain target data from another apparatus via the communication section 22.

The related term obtaining section 202 obtains a related term related to the target data obtained by the target data obtaining section 201. The method of obtaining the related term is not particularly limited. For example, if the target data includes a plurality of pieces of data as in the example of FIG. 3, the related term obtaining section 202 may extract the related term from the plurality of pieces of data. For example, in the example of FIG. 3, if the target data is the company name “YYY”, the related term obtaining section 202 may extract, as the related term, the business category “grocery” associated with the target data. It is preferable that the related term contribute to generation of the related string, so that it is preferable to avoid using, as the related term, terms that are not meaningful by themselves, such as identification information (ID) or the model numbers of apparatuses.

The target string generation section 203 generates a target string regarding the target data obtained by the target data obtaining section 201. The target string may be any string that includes contents regarding the target data, and the target string generation section 203 may generate, for example, at least one sentence regarding the target data, as the target string. It should be noted that the target string does not necessarily need to be a complete sentence, but may be a sentence with the end thereof missing or a sentence in which some words are missing.

For example, the target string generation section 203 may generate, as the target string, with use of a string indicating the name of the target data, at least one sentence including the string. Thus, in addition to the example advantage achieved by the information processing apparatus 1 in accordance with the first example embodiment, it is possible to achieve an example advantage of being capable of generating a target string with use of a string indicating the name of the target data, which is generally available data.

Further, with the foregoing configuration, since the use of a string indicating the name of target data to generate a sentence can provide a new nuance, it is possible to achieve an example advantage of being capable of causing a related string including desired attribute information to be outputted. For example, it is assumed that the target data is data regarding a company and the name of the company is a common noun indicating the name of a fruit. In this case, if a target string “The feature(s) of {name of company} is(are)” is generated, there is a possibility that a target string regarding the fruit will be generated. In such a case, for example, if a template “The feature(s) of a company named {name of company} is(are)” is used, it is now possible to generate a target string regarding the company rather than the fruit, and extract reasonable attribute information.

The name may be the trade name of a tangible product, the name of an intangible product or service, the place name, the recipe name, or the like, besides the company name. By using a name capable of recalling the target data, it is possible to generate a related string related to the target data. For example, by generating a target string including the trade name of “wine”, it is possible to extract attribute information regarding “wine”.

Further, since the information processing apparatus 2 includes the related term obtaining section 202 that obtains a related term related to target data, the target string generation section 203 can also generate, as the target string, at least one sentence including the related term. Thus, it is possible to extract attribute information regarding the related term. Thus, for example, even in a case where the name of target data is a string of numerals and symbols from which a meaningful target string cannot be generated, it is possible to achieve an example advantage of being capable of extracting attribute information related to a related term, which is thus related to the target data, in addition to the example advantage achieved by the information processing apparatus 1 in accordance with the first example embodiment.

Further, by using a sentence including a related term as a target string, it is possible to achieve an example advantage of being capable of causing the language model 212 to output a related string including desired attribute information. For example, in a case where target data is related to a store, a term indicating the business category of the store is obtained as a related term, so that it is possible to cause the language model 212 to output a related string including attribute information regarding the store of the business category.

The method of generating the target string is not particularly limited. For example, the target string generation section 203 may generate at least one sentence with use of a template prepared in advance, and use the generated sentence as the target string. Here, the template may be stored in advance in the storage section 21 or the like, or alternatively, the control section 20 of the information processing apparatus 2 may be provided with a template generation section, to cause the template generation section to generate a template.

Further, before inputting the name of the target data and the related term into the template, the target string generation section 203 may adjust the format of these pieces of data to be inputted into the template, to modify the format to a format suitable for input into the template. Thus, it is possible to generate the target string of a natural sentence. The above adjustment method is not particularly limited, and may be adjusted using, for example, a language model or the like.

As the template, for example, a template that receives, as input, a string indicating the name of target data and a related term obtained by the related term obtaining section 202, to complete a target string, may be used. For example, it is assumed that in a case where a template “The feature(s) of {related term} named {name of target data} is(are)” is used, the name of the target data is “XXX” and the related term is “supermarket”. In this case, the target string generation section 203 can generate, as the target string, a string “The features of the supermarket named XXX”, which is more precisely the beginning of a sentence. In addition, for example, use of a template “the feature(s) of {item name} that is present in {place name} is(are)” can limit the target string to a sentence regarding an item present in a specific area, to extract attribute information regarding the item present in the area. Here, the {place name} may be extracted from the input data 211 or the like.

The related string generation section 204 generates, from a target string regarding target data to which attribute information is to be added, a related string related to the target string with use of the language model 212 trained with relationships between terms.

The language model 212 is created by means of learning of the relationship between terms, and is a model that generates, from a target string, a related string related to the target string. With use of the language model 212 that has been trained with sentences and texts of various contexts, it is possible to generate the related string of reasonable contents related to the target string.

For example, the language model 212 may be trained to output at least one sentence including an inputted string. By using such a language model 212, the related string generation section 204 can generate, as the related string, at least one sentence including a target string. The sentence generated in this manner is related to the target data by including the target string and also includes new information regarding the target data. Thus, with this configuration, it is possible to achieve an example advantage of being capable of extracting new information regarding target data as attribute information, in addition to the example advantage achieved by the information processing apparatus 1 in accordance with the first example embodiment.

By way of a specific example, the language model 212 may be Generative Pre-Training-2 (GPT-2) or GPT-3 that outputs a sentence including an input string by predicting a string with a higher probability of following the input string. Alternatively, for example, a model such as Text-to-Text Transfer Transformer (T5) can be used as the language model 212.

In a case where the language model 212 as described in the foregoing is used, the related string generation section 204 may input the string outputted from the language model 212, into the language model 212 again. Further, this process may be repeated multiple times. Thus, it is possible to increase the amount of information included in the target string and increase the possibility that reasonable attribute information is extracted.

The attribute information extraction section 205 extracts attribute information from the related string generated by the related string generation section 204. The attribute information extraction section 205 also stores the extracted attribute information in the storage section 21 as result data. The attribute information extraction section 205 may store the extracted attribute information in association with the target data. The attribute information extraction section 205 may present the extracted attribute information to the user by, for example, causing the output section 24 to output the extracted attribute information.

As described in the foregoing, the information processing apparatus 2 includes: the related string generation section 204 that generates, from a target string regarding target data to which attribute information is to be added, a related string related to the target string with use of the language model 212 trained with relationships between terms; and the attribute information extraction section 205 that extracts the attribute information from the related string.

The related string generated from the target string with use of the language model trained with relationships between terms includes new information about the target data, which information is not included in the target string. Therefore, with the foregoing configuration, it is possible to extract new information regarding the target data as the attribute information. This makes it possible to add the attribute information to the target data without using a search query or the like. Here, “extracting the attribute information from the related string” includes use of the generated related string as it is as the attribute information.

### Method of Obtaining Related Term

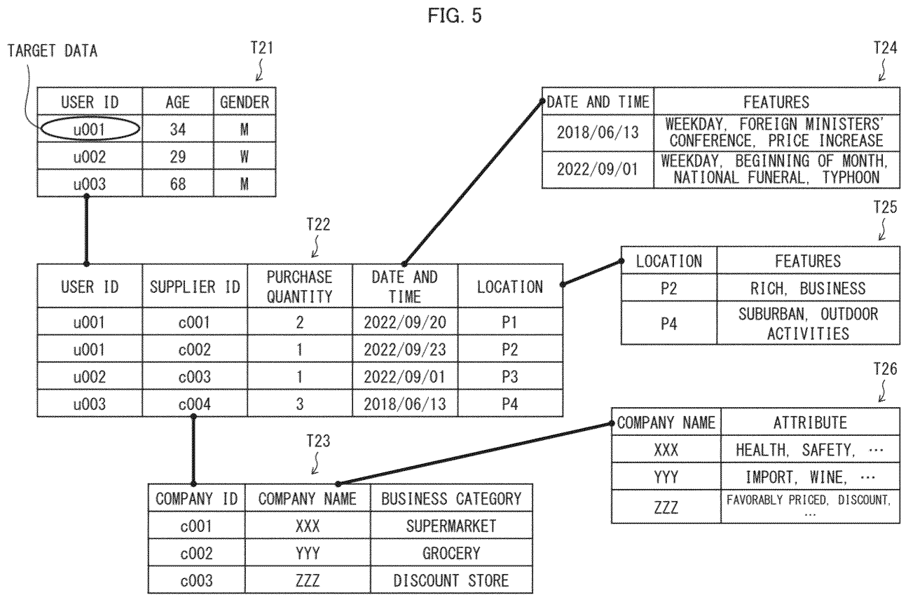

Another method of obtaining a related term will be described with reference to FIG. 5. FIG. 5 is a diagram illustrating an example of tables from which related terms are to be extracted. FIG. 5 illustrates table T21 including target data and tables T22 to T26 directly or indirectly associated with the table T21. The input data 211 may include a plurality of such tables, and the related term obtaining section 202 may extract related terms from these tables.

For example, the related term obtaining section 202 may obtain, as the related term, a term indicating age or gender associated with the target data from the table T21 including the target data. At this time, the related term obtaining section 202 may obtain, as the related term, a term obtained by replacing a numerical value included in the table T21 with a numerical range, or by replacing a symbol included in the table T21 with a word. For example, the related term obtaining section 202 may obtain “30s”, instead of “34”, which is a value of age associated with the target data, as the related term. Further, as the related term, the related term obtaining section 202 may obtain “male” instead of “M”, which is a value of gender associated with the target data. Here, such replacement is similarly applicable to information obtained from a table other than the table T21 in which the target data is included.

The related term obtaining section 202 may obtain the related term from the table T22 including “user ID”, which is a primary key in the table T21, as an foreign key, or alternatively, the related term obtaining section 202 may obtain the related term from the tables T23 to T25 associated with the table T22. Further, the related term obtaining section 202 may extract the related term from the table T26 associated with the table T23. In a case where the related term obtaining section 202 extracts the related term by tracing the tables related to each other in this manner, the table may be traced in order from the primary key to the foreign key (e.g., in order from table T21 to table T22), or alternatively, the table may be traced in order from the foreign key to the primary key (e.g., in order from table T22 to table T23).

In a case where the target string generation section 203 generates a target string including a related term as described above obtained from a plurality of sources, the target string generation section 203 may use a template created to allow input of a related term obtained from each source. For example, in a case where the target string generation section 203 generates a target string from two related terms extracted from the table T21 including the target data, the target string generation section 203 may use a template “The feature(s) of {gender} {age} is(are)”. In this case, a target string “The feature(s) of Male 30s is(are)” is generated.

For example, in a case where the target string generation section 203 generates a target string with use of two related terms extracted from the table T21 and a related term indicating “location” extracted from the table T22, the target string generation section 203 may use a template “The feature(s) of a {gender} {age} who goes on a shopping at {location} is(are)”. In this case, generated is a target string “The feature(s) of Male 30s who goes on a shopping at P1 is(are)”. Thus, the related term obtaining section 202 may obtain a related term from the table T21 including the target data and the table T22, which is one of the tables related to the table T21. In this case, the target string generation section 203 may generate the target string by inputting a related term extracted from each table into the template.

The related term obtaining section 202 may obtain related terms from the tables T23 to T26, which are indirectly associated with the table T21 including the target data. For example, the related term obtaining section 202 specifies, from the table T22, which is associated with the table T21 including the target data, that the IDs of the companies from which the user with a user ID of “u001” purchased products are “c001” and “c002”, and extracts the names of these companies, that is, “XXX” and “YYY” from the table T23, to use them as related terms. In this case, for example, the target string generation section 203 may use a template “The feature(s) of {gender} {age} interested in {feature extracted from table T3} is(are)”, and generate a target string “The feature(s) of Male 30s interested in XXX and YYY is(are)”. In this way, the related term obtaining section 202 can specify, with reference to the table T21 including the target data as the starting point, various kinds of data related to the target data, and then, the related term obtaining section 202 can obtain the related terms from these pieces of data. Here, these pieces of data may be inputted as the input data 211, or may be referred to from an external database or the like.

The related term obtaining section 202 may obtain two or more related terms; in this case, the target string generation section 203 may collectively use the obtained related terms and include them in the target string. For example, in the example of FIG. 5, the related term obtaining section 202 may refer to the table T22 to specify that the company IDs of the sources from which a user with a user ID of “u001” purchases the product, are “c001” and “c002”, and the related term obtaining section 202 may further refer to the tables T23 and T26, to specify the attributes of these companies, which are “health” and “safety”, and “import” and “wine”, and extract these terms as the related terms. In this way, the target string generation section 203 can generate, using, for example, a template “The feature(s) of {gender} {age} who is interested in {related term} is(are)”, a target string “The feature(s) of Male 30s who is interested in health, safety, import, and wine is(are)”.

Thus, by extracting related terms from various kinds of data associated with the target data, it is possible to extract reasonable attribute information even in a case where the target data is something that cannot be recalled from itself, such as the user ID or the model number of the device.

### Collection of Attribute Information of Similar Data

The information processing apparatus 2 may extract attribute information of similar data similar to the target data, and collectively output the extracted attribute information and the attribute information of the target data. The criterion of “similarity” may be freely chosen. For example, a user who is close in age may be a similar user. In this case, in a case where data of a user is specified as the target data, the target data obtaining section 201 may obtain data of another user who is close in age to the specified user as similar data. For example, it is assumed that data having a user ID of “u011” in the table T21 of FIG. 5 is designated as target data. In this case, the target data obtaining section 201 may obtain, as the similar data, data of a user within a predetermined range in age (e.g., 34±5 years) with respect to an age of “34”, which is associated with “u011”. Further, the target data obtaining section 201 may obtain data of a user of the same age group (e.g., 30s) as the similar data.

Then, similarly to the target data, the similar data undergoes: obtaining of the related term carried out by the related term obtaining section 202; generation of the target string carried out by the target string generation section 203; generation of the related string carried out by the related string generation section 204; and extraction of the attribute information carried out by the attribute information extraction section 205. In this way, the attribute information is extracted for each of the target data and the similar data (, which may be one or more pieces of data), so that the attribute information extraction section 205 may collect them into final attribute information.

For example, the attribute information extraction section 205 may use, as the attribute information of the target data, a sum of sets of the attribute information corresponding to both the target data and the similar data, or alternatively, the attribute information extraction section 205 may use, as the attribute information of the target data, attribute information extracted from the sum of sets. The method of extracting the attribute information will be described under the item “Extraction of attribute information” described later.

Further, for example, the attribute information extraction section 205 may use, as the attribute information of the target data, a difference set obtained by subtracting a set of the attribute information corresponding to the target data from a sum of sets of the attribute information corresponding to the similar data, or alternatively, the attribute information extraction section 205 may use, as the attribute information of the target data, the attribute information extracted from the difference set. In this way, although not directly related to the user “u011”, it is possible to extract the attribute information related to another user similar to the user “u011”. With this configuration, for example, it is possible to extract, as the attribute information, information expected to be interested in by the user “u011” in the future, and information that may be useful in recommending a product to the user “u011”.

### Another Example of Target String

As described above, the target string generation section 203 can generate the target string using various strings such as the name of the target data and the related term. Further, in a case where there is data similar to the target data on some criterion (i.e., abovementioned similar data) or data to be compared (hereinafter, referred to as “comparative target data”), the target string generation section 203 may generate the target string using these pieces of data.

For example, using a template “The feature(s) of {name of target data} in comparison with {name of comparative target data}”, the target string generation section 203 may generate the target string. This makes it possible to extract the attribute information regarding a difference between the target data and the comparative target data. For example, in a case where the table T1 illustrated in FIG. 3 is inputted, the target string generation section 203 can generate, using the abovementioned template with “YYY” used as the comparative target data, a target string “The feature(s) of XXX in comparison with YYY is(are)”. Then, the related string generation section 204 can generate, using this target string, a target string such as “The feature(s) of XXX in comparison with YYY is(are) a difference in sales per customer”. This makes it possible to extract the attribute information regarding the difference between “XXX” and “YYY”, that is, “sales per customer”. The same applies to a case where a template “{name of target data} exceeds {name of comparative target data} in that” is used. Further, a similar target string can also be generated for the similar data.

Here, the method of selecting the comparative target data and the similar data, and the criteria of comparison may be freely chosen. For example, as the comparative target data or the similar data, the target string generation section 203 may select data of the same category as the target data. In a case where the target data is related to a store, a company, or the like, the target string generation section 203 may select data of stores, companies, or the like located in the same area, as the comparative target data or the similar data. Further, the target string generation section 203 may select, as the similar data, data close to the associated numerical value. For example, in a case where the target data is related to a store, and its sales amount is known, it is possible to use data regarding another store having the sales amount approximating to that of the store, as the similar data.

Further, in a case where the attribute information of data to be compared is known, the target string generation section 203 may generate the target string using the attribute information. This makes it possible to increase the probability of extraction of reasonable attribute information. For example, in a case where the target data is the name of a store “XXX” and it is required to obtain attribute information indicating a feature of the store, the target string generation section 203 may generate a target string, using “The feature(s) of {name of data to be compared} is(are) {attribute of data to be compared}. At this time, the feature(s) of {name of target data} is(are)”, for example. By inputting the name of the store “XXX”, which is the target data, the name of another store “YYY”, and the attribute information of the another store “low price”, the target string generation section 203 can generate a target string “The feature(s) of YYY is(are) low price. At this time, the feature(s) of XXX is(are)”. This makes it possible to extract the attribute information indicating a feature regarding the sale strategy of “XXX”. Here, the data to be compared may include multiple pieces of data. In this case, each piece of data to be compared and a template in which features of the data is listed may be used.

Even if the target data is a string that is not included in a corpus used for training of the language model 212 (e.g., new terms, creative terms, terms used only in some areas, etc.), it is possible to extract the attribute information related to the target string by generating a target string including a related term and the like and inputting the target string into the language model 212. For example, in a case where the name of the target data is a combination of a personal name and a common noun, it can be expected that a related string including attribute information related to the target data can be outputted if the language model 212 trained with a corpus including its common noun part is used.

In a case where a target string including the target data and the related terms is generated, it can be expected that a related string taking into account a component of the related term can be outputted if the language model 212 trained with a corpus including the related term is used. For example, in a case where the term “supermarket” is obtained as the related term even if the name “XXX” is not included in the corpus, it is possible to generate a target string “The supermarket named XXX is”, to thereby generate a related string taking into account the “supermarket”.

### Example of Use of Another Language Model

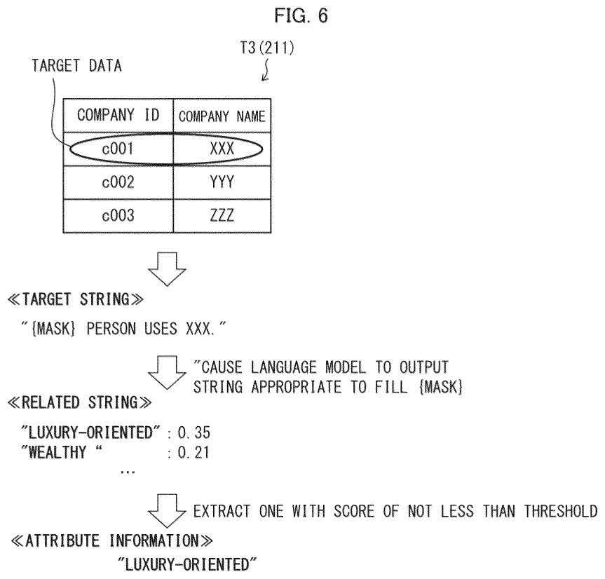

The language model 212 described in the foregoing may be trained to output, in response to input of a sentence having a missing part, a string appropriate to fill the missing part. This will be described with reference to FIG. 6. FIG. 6 is a diagram illustrating an example in which attribute information is extracted with use of the language model 212 trained to output, in response to input of a sentence having a missing part, a string appropriate to fill the missing part.

FIG. 6 illustrates an example in which table T3, which includes company IDs and company names, is given as the input data 211, and a record with a company ID of “c001” included in the table T3 is designated as the target data.

Here, the target string generation section 203 generates, as the target string, at least one sentence in which a part that indicates an attribute of the target data is missing. Specifically, in the example of FIG. 6, the target string generation section 203 inputs a string “XXX” extracted from the target data into a template “{MASK} person uses {company name}”, to generate a target string “{MASK} person uses XXX”. This {MASK} part is a part that indicates the attribute of the target data. Here, the {MASK} part may be located at the beginning, end, or middle of the sentence. Further, the target string generation section 203 may generate a target string including a term or the like regarding data to be compared with the related term or target data.

Next, the related string generation section 204 inputs the target string into the language model 212 to output a set of strings (typically terms) that is appropriate to fill the {MASK} part. Here, the number of elements of the set is 1 or more.

The language model 212 used herein is trained to output, in response to input of a sentence having a missing part, a string appropriate to fill the missing part. For example, as the language model 212, a model such as Bidirectional Encoder Representations from Transformers (BERT), Robustly optimized BERT approach (ROBERTa), Efficiently Learning an Encoder that Classifies Token Replacements Accurately (ELECTRA), or the like may be used, to output such a string.

In the example of FIG. 6, two terms “luxury-oriented” and “wealthy” are outputted as the related string, and a numerical value corresponding to each term is outputted simultaneously. This numerical value is a score that indicates the likelihood that the term will be appropriate to fill the {MASK} part. The language model 212 may be a model that outputs such a score, together with a term appropriate to fill the {MASK} part.

Further, the attribute information extraction section 205 extracts the attribute information from the related string (in this example, a set of terms) generated by the related string generation section 204. The attribute information extraction section 205 may extract, as the attribute information, the entire related string generated by the related string generation section 204, or alternatively, the attribute information extraction section 205 may extract, as the attribute information, a part of the related string generated by the related string generation section 204.

In a case where a part of the related string is extracted as the attribute information, the attribute information extraction section 205 may select the related string to be extracted as the attribute information based on the abovementioned score. In the example of FIG. 6, as the attribute information, the attribute information extraction section 205 extracts “luxury-oriented” having a score of not less than a threshold.

As described above, the target string generation section 203 may generate, as the target string, at least one sentence in which a part that indicates an attribute of the target data is missing. In this case, the related string generation section 204 generates the related string by inputting the target string into the language model 212 trained to output, in response to input of a sentence having a missing part, a string appropriate to fill the missing part.

With this configuration, it is possible to generate, as the related string, a string appropriate to fill the missing part in the target string, that is, the part indicating an attribute of the target data. Therefore, the attribute information extraction section 205 can extract reasonable attribute information from the related string thus generated.

Further, the target string generation section 203 may generate, as the target string, a question sentence regarding an attribute of the target data. In this case, the related string generation section 204 generates the related string by inputting the target string into the language model 212 trained to output, in response to input of a question sentence, a string answering the question sentence.

With this configuration, it is possible to generate, as the related string, a string that answers the question sentence regarding the attribute of the target data. Since the string that answers the question sentence regarding the attribute of the target data is likely to include information indicating the attribute of the target data, the attribute information extraction section 205 can extract reasonable attribute information from the related string thus generated.

For example, the target string generation section 203 may input “XXX” extracted from the target data illustrated in FIG. 6 into a template “What is(are) the feature(s) of {name of target data}?”, to generate a question sentence “What is(are) the feature(s) of XXX?”, which may be used as the target string. In this way, the target string generation section 203 can generate a target string, which is a question sentence, by using a template of the question sentence. In this case, as the language model 212, a model trained with relationships between various question sentences and their answers may be used. The question sentence may be a sentence that directly queries the attribute of the target data as in the example described above, or alternatively, the question sentence may be a sentence expected to answer the question sentence with information indicating the attribute, such as “What does {Name of target data} make you think of?”. The string of an answer outputted from the language model 212 may include one or more terms, may be a sentence, or may be a text including two or more sentences. If, for example, Generative Pre-trained Transformer (GPT) or the like is used as the language model 212, one or more sentences may be outputted as an answer string for a question sentence.

### Extraction of Attribute Information

### Extraction From a Set of Terms

The following description will discuss extraction of attribute information carried out by the attribute information extraction section 205. As described above, in a case where a target string is a set of terms, the attribute information extraction section 205 may extract a part or the entirety of the target string as the attribute information based on the abovementioned score or the like. For example, the attribute information extraction section 205 may extract, as the attribute information, k term(s) (k is an integer of not less than 1) having higher scores, or alternatively, the attribute information extraction section 205 may extract, as the attribute information, a term having a score of not less than a predetermined threshold.

### Extraction From Sentence

In a case where a target string is a sentence or a part of a sentence, the attribute information extraction section 205 may extract at least one or all of terms included in the target string as attribute information. In this case, the attribute information extraction section 205 may extract a term by subjecting the target string to morphological analysis, and use at least one or all of the extracted terms as the attribute information. In a case where at least one but not all extracted terms is used as the attribute information, the attribute information extraction section 205 may use a term of a predetermined word class as the attribute information. It may be freely chosen what term of what word class is used as the attribute information. For example, the attribute information extraction section 205 may extract a noun or a verb as the attribute information, or may extract only a proper noun as the attribute information.

For example, it is assumed that the target string is “The feature(s) of XXX is(are) a wide selection of products and high quality of products”. Of these, the “The feature(s) of XXX is(are)” part at the beginning is the target data and the accompanying template part. Thus, the attribute information extraction section 205 may exclude this beginning part from a target from which the attribute information is extracted, and carry out morphological analysis on the remainder. Thus, terms such as “wide”, “selection of products”, “and”, “qualities of products”, and the like are extracted. If the word class targeted for extraction is noun, the attribute information extraction section 205 extracts “selection of products”, “wide”, and “qualities of products” of these terms as the attribute information.

### Extraction Based on Frequency of Occurrence

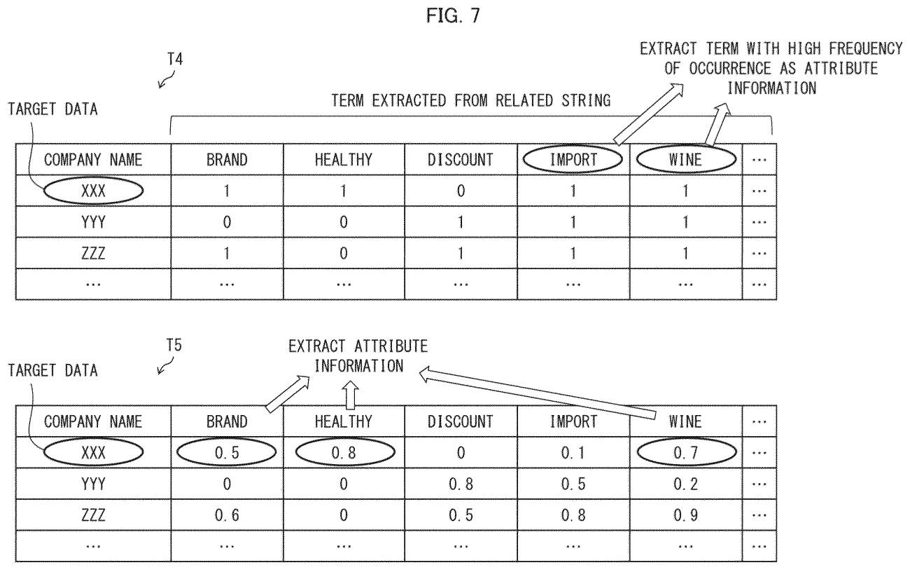

Further, the attribute information extraction section 205 may extract the attribute information based on the frequencies of occurrence of terms extracted from two or more related strings. This will be described with reference to FIG. 7. FIG. 7 is a diagram illustrating an example of extracting attribute information based on frequencies of occurrence of terms extracted from two or more related strings. Table T4 illustrated in FIG. 7 shows terms extracted from related strings related to multiple company names such as “XXX”, “YYY”, and “ZZZ”. Each numeral shown in the table T4 indicates the number of extracted terms. For example, the table T4 shows that the number of term “brand” extracted from each of the related strings of “XXX” and “ZZZ” is one, and the number of term “brand” extracted from the related string of “YYY” is zero (i.e., not extracted).

The attribute information extraction section 205 can calculate the frequency of occurrence of each term by counting the number of occurrences of terms extracted from each related string in this way, so that the attribute information extraction section 205 can select a term to be extracted as the attribute information based on the calculated frequencies of occurrence. For example, the attribute information extraction section 205 may extract, as the attribute information, k term(s) (k is an integer of not less than 1) having higher frequencies of occurrence, or alternatively, the attribute information extraction section 205 may extract, as the attribute information, a term having a frequency of occurrence of not less than a predetermined threshold.

It should be noted that the language model 212 may return different outputs for the same input, due to effects of random numbers or the like. Thus, the related string generation section 204 may input the same target string into the language model 212 multiple times, to generate two or more related strings. The related string generation section 204 may input target strings into a plurality of different language models 212, to generate two or more related strings. In these cases, the attribute information extraction section 205 may select, based on the frequencies of occurrence of terms extracted from each related string, a term to be extracted as the attribute information.

### Extraction Based on Weighted Frequency of Occurrence

For example, the attribute information extraction section 205 may extract the attribute information based on a weighted frequency. Table T5 illustrated in FIG. 7 shows terms extracted from related strings related to the multiple company names such as “XXX”, “YYY”, and “ZZZ” as in the table T4. Each numeral shown in the table T5 indicates the value of the weighted frequency of each term. For example, the table T5 shows that the value of the weighted frequency of term “brand” extracted from a related string of the company name “XXX”, which is the target data, is 0.5.

For example, the attribute information extraction section 205 may calculate the weighted frequency by Term Frequency-Inverse Document Frequency (TF-IDF). The TF-IDF is calculated based on the frequency of occurrence of a term and the number of sentences each including the term; the TF-IDF value of a term included in a large number of sentences is low even if the frequency of occurrence is high, and the TF-IDF value of a term included in a small number of sentences with a high frequency of occurrence in that sentence is high.

Specifically, the value of the weighted frequency is a value obtained by multiplying the term frequency (TF) value by the inverse document frequency (IDF) value as the weight. In the example of FIG. 7, the attribute information extraction section 205 calculates TF-IDF for a matrix (table T4) that indicates the frequency at which each term is extracted from the related string. Each numerical value shown in the table T5 indicates a calculation result of the TF-IDF value for a set of each term and a related string from which the term is extracted.

The value of TF-IDF indicates how important each term included in each sentence is in the sentence. Therefore, by calculating the weighted frequency by using the TF-IDF and by extracting attribute information based on the calculated value, the attribute information extraction section 205 can extract the more important term as the attribute information. The method of calculating the weighted frequency is not particularly limited, and the attribute information extraction section 205 may, for example, calculate the weighted frequency by using the Best Matching (BM) 25 or the like.

By calculating the weighted frequency of each term as described in the foregoing, the attribute information extraction section 205 can extract the attribute information based on the weighted frequency. For example, the attribute information extraction section 205 may extract, as the attribute information, k term(s) (k is an integer of not less than 1) having higher weighted frequencies, or alternatively, the attribute information extraction section 205 may extract, as the attribute information, a term having a weighted frequency of not less than a predetermined threshold. In the example of FIG. 7, regarding the company name “XXX”, which is the target data, three terms, “brand”, “healthy”, and “wine”, each having a higher weighted frequency, are extracted as the attribute information.

As described above, the related string generation section 204 may generate two or more related strings, targeting one or both of the target data and another data. Further, the attribute information extraction section 205 may extract, as the attribute information, one or more terms selected from terms included in the related string corresponding to the target data based on the frequency of occurrence of each term included in the two or more related strings.

In a case where two or more related strings are generated targeting one or both of the target data and another data, terms included in the respective related strings can be different from each other. Then, the frequency of occurrence of each term in their related string can be an index for determining the suitability of that term as the attribute information. Thus, with this configuration, it is possible to achieve an example advantage of being capable of extracting, as the attribute information, a term with high suitability for the attribute information, in addition to the example advantage achieved by the information processing apparatus 1 in accordance with the first example embodiment.

It should be noted that the extraction criteria for the attribute information are not limited to the frequency of occurrence. For example, the attribute information extraction section 205 may extract, as the attribute information, one or more terms randomly selected from terms included in a related

### Extraction Based on Analytical Purpose

The attribute information extraction section 205 may extract, as the attribute information, a term suitable for an analytical purpose. For example, the attribute information extraction section 205 may extract, as the attribute information, one or more terms selected from one or more terms included in a related string, based on a similarity to a predetermined term. Thus, it is possible to achieve an example advantage of being capable of extracting, as the attribute information, a term selected by criteria using the similarity to a predetermined term, in addition to the example advantage achieved by the information processing apparatus 1 in accordance with the first example embodiment. For example, a term having a high similarity to a predetermined term may be extracted as the attribute information, or alternatively, a term having a low similarity to a predetermined term may be extracted as the attribute information.

The attribute information extraction section 205 can extract, as the attribute information, a term having a high similarity to a keyword corresponding to the analytical purpose, to extract, as the attribute information, a term suitable for the analytical purpose. For example, in a case where the analytical purpose is to search for needs of child-rearing households, the attribute information extraction section 205 may extract, as the attribute information, a term having a high similarity to the term “child rearing”. This makes it possible to extract a term indicating the needs of child-rearing households as the attribute information.

The method of calculating the similarity between terms may be freely chosen. For example, the attribute information extraction section 205 may obtain each term represented by a vector with use of a model that generates the embedding of a term, such as Word2Vec and fastText, to calculate the cosine similarity thereof. For example, the attribute information extraction section 205 may calculate the cosine similarity between each term included in the related string and a predetermined term, to extract, as the attribute information, a term having a maximum value not less than a predetermined threshold. For example, the attribute information extraction section 205 may extract, as the attribute information, k term(s) (k is an integer of not less than 1) having higher maximum values of the cosine similarity.

### Flow of Processing: Attribute Information Extraction Method

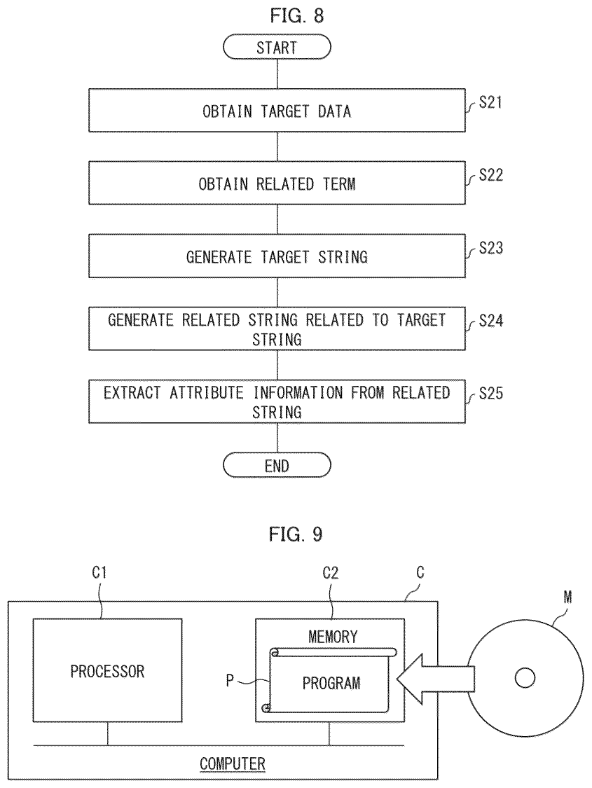

The following description will discuss the flow of attribute information extraction method carried out by the information processing apparatus 2 with reference to FIG. 8. FIG. 8 is a flowchart illustrating the flow of the attribute information extraction method in accordance with the present example embodiment. FIG. 8 illustrates processing after the input of the input data 211.

In S21, the target data obtaining section 201 obtains target data to which the attribute information is to be added. For example, the target data obtaining section 201 may obtain, as the target data, a piece of data selected from the data included in the input data 211.

In S22, the related term obtaining section 202 obtains a related term of the target data obtained in S21. The related term may be, for example, data included in the target data, or alternatively, may be data associated with the target data (e.g., data directly or indirectly associated with the target data in the input data 211).

In S23, the target string generation section 203 generates a target string related to the target data obtained in S21. For example, the target string generation section 203 may generate the target string by inputting, into a predetermined template, a string indicating the name of the target data obtained in S21 and the related term obtained in S22.

In S24, the related string generation section 204 generates, from the target string generated in S23, a related string related to the target string with use of the language model 212 trained with relationships between terms. The language model 212 used may be trained to output a sentence or part of a sentence, may be trained to output a string appropriate to fill a missing part of a sentence, or may be trained to output a question sentence.

Here, in S23, the target string is generated in a format that conforms to the language model 212 to be used. For example, in a case where the language model 212 trained to output the latter half of the sentence in S24 is used, the first half of the sentence is generated as the target string in S23.

Here, the user may be allowed to select which language model 212 to use. In this case, user's designation of the language model 212 is received at a timing earlier than S23. Then, in S23, the target string is generated in accordance with the language model 212 selected by the user, and in S24, the related string is generated by the language model 212 selected by the user.

In S25, the attribute information extraction section 205 extracts attribute information from the related string generated in S24. Then, the attribute information extraction section 205 stores the extracted attribute information in the storage section 21 or the like; this terminates the operation of FIG. 8. Here, the attribute information extraction section 205 may cause the output section 24 or the like to output the extracted attribute information.

As described in the foregoing, the attribute information extraction method in accordance with the present example embodiment includes: generating, from a target string regarding target data to which attribute information is to be added, a related string related to the target string with use of the language model 212 trained with relationships between terms (S24); and extracting the attribute information from the related string (S25). With this attribute information extraction method, it is possible to add attribute information to target data without using a search query or the like.

The abovementioned processes of S21 to S25 may be repeatedly carried out while changing the target data. Thus, the attribute information is extracted for each of the plurality of target data. In this case, the attribute information extraction section 205 can determine the final attribute information of each piece of the target data based on the frequency of occurrence of each term extracted as the attribute information.

For example, it is assumed that the attribute information is extracted for each of three company names “XXX”, “YYY”, and “ZZZ”, as shown in the table T1 of FIG. 3. In this case, the attribute information extraction section 205 may count the number of occurrences of each term extracted as the attribute information and may calculate the frequency of occurrence of each term from the counted number of occurrences, to determine the final attribute information based on the frequency of occurrence (see the table T4 in FIG. 7). The attribute information extraction section 205 may determine the final attribute information based on the weighted frequency of occurrence (see the table T5 in FIG. 7).

In a case where the target data obtained in S21 includes a string, the processes in S22 and S23 may be omitted. In this case, in S24, the related string may be generated by inputting, as the target string, the string included in the target data obtained in S21, into the language model 212. Further, at this time, it may be repeated to input the generated related string into the language model 212, to generate a related string including more information.

### Variations

Any subject may carry out each process described in the foregoing example embodiments, and is not limited to the examples described above. That is, the functions of the information processing apparatus 2 can be implemented by a plurality of information processing apparatuses (also may be referred to as processors) capable of communicating with each other. For example, each process illustrated in the flowchart of FIG. 8 may be carried out by the plurality of information processing apparatuses in a shared manner. That is, the subject of execution of the control method in the foregoing example embodiments may be one information processing apparatus 2 or may be a plurality of information processing apparatuses.

### Software Implementation Example

Some or all of the functions of the information processing apparatuses 1 and 2 may be implemented by hardware such as an integrated circuit (IC chip), or may be alternatively implemented by software.

In the latter case, each of the information processing apparatuses 1 and 2 is implemented by, for example, a computer that executes instructions of a program that is software implementing the foregoing functions. FIG. 9 illustrates an example of such a computer (hereinafter referred to as “computer C”). The computer C includes at least one processor C1 and at least one memory C2. The memory C2 stores a program (attribute information extraction program) P for causing the computer C to operate as the information processing apparatus 1 or 2. The processor C1 of the computer C retrieves the program P from the memory C2 and executes the program P, so that the functions of the information processing apparatus 1 or 2 are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 can be, for example, a flash memory, a hard disk drive (HDD), a solid state drive (SSD), or a combination of these.

Note that the computer C may further include a random access memory (RAM) in which the program P is loaded if the program P is executed and/or in which various kinds of data are temporarily stored. The computer C may further include a communication interface via which data is transmitted to and received from another apparatus. The computer C may further include an input/output interface for connecting the computer C to an input/output apparatus(es) such as a keyboard, a mouse, a display and/or a printer.

The program P can be recorded in a non-transitory tangible storage medium M from which the computer C can read the program P. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P also via such a transmission medium.

### Additional Remark 1

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

An information processing apparatus including: related string generation means for generating, from a target string regarding target data to which attribute information is to be added, a related string related to the target string with use of a language model trained with relationships between terms; and attribute information extraction means for extracting the attribute information from the related string.

### Supplementary Note 2

The information processing apparatus according to Supplementary note 1, wherein the related string generation means uses the language model trained to output at least one sentence including an inputted string, to generate, as the related string, at least one sentence including the target string.

### Supplementary Note 3

The information processing apparatus according to Supplementary note 1, further including target string generation means for generating, as the target string, at least one sentence in which a part that indicates an attribute of the target data is missing, wherein the related string generation means generates the related string by inputting the target string into the language model trained to output, in response to input of a sentence having a missing part, a string appropriate to fill the missing part.

### Supplementary Note 4

The information processing apparatus according to Supplementary note 1, further including target string generation means for generating, as the target string, a question sentence regarding an attribute of the target data, wherein the related string generation means generates the related string by inputting the target string into the language model trained to output, in response to input of a question sentence, a string that answers the question sentence.

### Supplementary Note 5

The information processing apparatus according to Supplementary note 1 or 2, further including target string generation means for generating, as the target string, with use of a string indicating a name of the target data, at least one sentence including the string.

### Supplementary Note 6

The information processing apparatus according to Supplementary note 1 or 2, further including: related term obtaining means for obtaining a related term related to the target data; and target string generation means for generating, as the target string, at least one sentence including the related term.

### Supplementary Note 7

The information processing apparatus according to any one of Supplementary notes 1 to 6, wherein the related string generation means generates two or more related strings, targeting one or both of the target data and another data, and the attribute information extraction means extracts, as the attribute information, one or more terms selected from terms included in the related string corresponding to the target data based on a frequency of occurrence of each term included in the two or more related strings.

### Supplementary Note 8

The information processing apparatus according to any one of Supplementary notes 1 to 8, wherein the attribute information extraction means extracts, as the attribute information, one or more terms selected from one or more terms included in the related string based on a similarity to a predetermined term.

### Supplementary Note 9

An attribute information extraction method including: generating, by at least one processor, from a target string regarding target data to which attribute information is to be added, a related string related to the target string with use of a language model trained with relationships between terms; and extracting, by the at least one processor, the attribute information from the related string.

### Supplementary Note 10

An attribute information extraction program causing a computer to function as: related string generation means for generating, from a target string regarding target data to which attribute information is to be added, a related string related to the target string with use of a language model trained with relationships between terms; and attribute information extraction means for extracting the attribute information from the related string.

### Supplementary Note 11

An information processing apparatus including at least one processor, the at least one processor carrying out: a process of generating, from a target string regarding target data to which attribute information is to be added, a related string related to the target string with use of a language model trained with relationships between terms; and a process of extracting the attribute information from the related string.

It should be noted that the information processing apparatus may further include a memory, which may store therein the attribute information extraction program for causing the at least one processor to carry out: a process of calculating the similarity, the process of generating the related string; and the process of extracting the attribute information. Alternatively, the attribute information extraction program may be stored in a computer-readable, non-transitory, tangible storage medium.

### REFERENCE SIGNS LIST

1 Information processing apparatus
11 Related string generation section (related string generation means)
12 Attribute information extraction section (attribute information extraction means)
2 Information processing apparatus
202 Related term obtaining section (related term obtaining means)
203 Target string generation section (target string generation means)
204 Related string generation section (related string generation means)
205 Attribute information extraction section (attribute information extraction means)

What is claimed is:

1. An information processing apparatus comprising at least one processor, the at least one processor carrying out:
a related string generation process of generating, from a target string regarding target data to which attribute information is to be added, a related string related to the target string with use of a language model trained with relationships between terms; and
an attribute information extraction process of extracting the attribute information from the related string.

2. The information processing apparatus according to claim 1, wherein in the related string generation process, the at least one processor uses the language model trained to output at least one sentence including an inputted string, to generate, as the related string, at least one sentence including the target string.

3. The information processing apparatus according to claim 1, the at least one processor carrying out a target string generation process of generating, as the target string, at least one sentence in which a part that indicates an attribute of the target data is missing,
wherein in the related string generation process, the at least one processor generates the related string by inputting the target string into the language model trained to output, in response to input of a sentence having a missing part, a string appropriate to fill the missing part.

4. The information processing apparatus according to claim 1, the at least one processor carrying out a target string generation means for process of generating, as the target string, a question sentence regarding an attribute of the target data,
wherein in the related string generation process, the at least one processor generates the related string by inputting the target string into the language model trained to output, in response to input of a question sentence, a string that answers the question sentence.

5. The information processing apparatus according to claim 1, the at least one processor carrying out a target string generation process of generating, as the target string, with use of a string indicating a name of the target data, at least one sentence including the string.

6. The information processing apparatus according to claim 1, the at least one processor carrying out:
a related term obtaining process of obtaining a related term related to the target data; and
a target string generation process of generating, as the target string, at least one sentence including the related term.

7. The information processing apparatus according to claim 1, wherein
in the related string generation process, the at least one processor generates two or more related strings, targeting one or both of the target data and another data, and
in the attribute information extraction process, the at least one processor extracts, as the attribute information, one or more terms selected from terms included in the related string corresponding to the target data based on a frequency of occurrence of each term included in the two or more related strings.

8. The information processing apparatus according to any claim 1, wherein in the attribute information extraction process, the at least one processor extracts, as the attribute information, one or more terms selected from one or more terms included in the related string based on a similarity to a predetermined term.

9. An attribute information extraction method comprising:
generating, by at least one processor, from a target string regarding target data to which attribute information is to be added, a related string related to the target string with use of a language model trained with relationships between terms; and
extracting, by the at least one processor, the attribute information from the related string.

10. A computer-readable non-transitory storage medium storing an attribute information extraction program for causing a computer to carry out:
a related string generation process of generating, from a target string regarding target data to which attribute information is to be added, a related string related to the target string with use of a language model trained with relationships between terms; and
an attribute information extraction process of extracting the attribute information from the related string.
